(19) United States
(12) Patent Application Publication
(10) Pub. No.: US 2025/0293979 A1
(43) Pub. Date: Sep. 18, 2025

(54) ONBOARD DEVICE, DATA PROVISION METHOD, AND STORAGE MEDIUM STORING PROGRAM

(71) Applicant: DENSO CORPORATION, Kariya-city (JP)

(72) Inventor: Motoki Sato, Kariya-city (JP)

(21) Appl. No.: 19/221,176

(22) Filed: May 28, 2025

Related U.S. Application Data
(63) Continuation of application No. PCT/JP2023/044907, filed on Dec. 14, 2023.

(30) Foreign Application Priority Data
Dec. 28, 2022 (JP) 2022-212065

(51) Int. Cl. H04L 47/12; G07C 5/08; H04L 12/40; H04L 47/2475

(52) U.S. Cl. CPC H04L 47/12; G07C 5/0808; H04L 12/40; H04L 47/2475; H04L 2012/40215; H04L 2012/40273

(57) ABSTRACT

An onboard device is configured to execute a transmission process to send a command used to acquire vehicle data to an in-vehicle network; execute at least one application program that utilizes the vehicle data; extract, as a transmission target command, the command indicated by management information that meets an acquisition condition, using one or more management information indicating a type of the command, a requesting application, and the acquisition condition; generate routing information associating the transmission target command with the requesting application; and provide the vehicle data to the requesting application based on the routing information.

### CROSS REFERENCE TO RELATED APPLICATION

The present application is a continuation application of International Patent Application No. PCT/JP2023/044907 filed on Dec. 14, 2023 which designated the U.S. and claims the benefit of priority from Japanese Patent Application No. 2022-212065 filed on Dec. 28, 2022. The entire disclosures of all of the above applications are incorporated herein by reference.

### TECHNICAL FIELD

The present disclosure relates to a technology for providing vehicle data to an application program operating on an onboard device connected to an in-vehicle network.

### BACKGROUND

A related art describes a device that performs diagnostic communication using data transmitted and received between ECUs via an in-vehicle network such as CAN to conduct fault diagnosis. CAN is a registered trademark. In diagnostic communication, a diagnostic tester is connected to a dedicated connector such as an OBD port provided in the vehicle. The diagnostic tester sends a request message to the ECU, and the ECU replies with a response message. OBD stands for on-board diagnostic.

### SUMMARY

An onboard device is configured to execute a transmission process to send a command used to acquire vehicle data to an in-vehicle network; execute at least one application program that utilizes the vehicle data; extract, as a transmission target command, the command indicated by management information that meets an acquisition condition, using one or more management information indicating a type of the command, a requesting application, and the acquisition condition; generate routing information associating the transmission target command with the requesting application; and provide the vehicle data to the requesting application based on the routing information.

### BRIEF DESCRIPTION OF DRAWINGS

Objects, features and advantages of the present disclosure will become more apparent from the following detailed description made with reference to the accompanying drawings. In the drawings:

FIG. 1 is a block diagram showing the functional configuration of the data provision system;

FIG. 2 is a block diagram showing the hardware configuration of the cloud server;

FIG. 3 is a block diagram showing the hardware configuration of the onboard device;

FIG. 4 is an explanatory diagram showing the structure of the manifest;

FIG. 5 is an explanatory diagram showing the structure of the command management table;

FIG. 6 is a sequence diagram showing the operation of each part of the system when the onboard device is powered on;

FIG. 7 is a sequence diagram showing the operation during the distribution of diagnostic applications;

FIG. 8 is a sequence diagram showing the operation during the transmission of diagnostic commands;

FIG. 9 is a sequence diagram showing the operation when receiving a response to a diagnostic command;

FIG. 10 is a flowchart showing the content of the schedule adjustment process;

FIG. 11 is an explanatory diagram illustrating the requests for diagnostic commands extracted at each tick;

FIG. 12 is an explanatory diagram showing the operation when requests for diagnostic commands overlap;

FIG. 13 is an explanatory diagram showing the operation when there is a possibility of CAN bus overload;

FIG. 14 is an explanatory diagram of the command transmission method;

FIG. 15 is an explanatory diagram showing an example of setting a transmission schedule to prevent diagnostic commands from concentrating on the same tick; and

FIG. 16 is a sequence diagram showing the operation during the measurement of turnaround time.

### DETAILED DESCRIPTION

As a result of detailed investigations by the inventor, the following issues have been identified. Specifically, the number of ports for diagnostic communication installed in a vehicle is usually one, and a single diagnostic tester is connected to it. The diagnostic tester executes only one application, which means it can only be used for a single purpose and by a single use.

The present disclosure provides a technology that enables the simultaneous use of an onboard device connected to an in-vehicle network for multiple purposes.

One aspect of the present disclosure is an onboard device including a data acquisition unit, an application execution unit, a schedule management unit, and a routing unit. The data acquisition unit is configured to execute a transmission process to send a command used to acquire vehicle data to an in-vehicle network. The application execution unit is configured to execute one or more application programs that utilize the vehicle data acquired by the data acquisition unit. The schedule management unit is configured to extract, as a transmission target command that is a command to be a transmission target in the transmission process, the command indicated by management information that meets an acquisition condition, using one or more management information indicating a type of the command used to acquire the vehicle data, a requesting application that is the application program to be a request source of the vehicle data, and the acquisition condition of the vehicle data. The schedule management unit is configured to generate routing information associating the transmission target command with the requesting application. The routing unit is configured to provide the vehicle data acquired by the data acquisition unit through execution of the transmission process to the requesting application using the routing information.

According to this configuration, vehicle data acquired via the in-vehicle network can be provided to the requesting applications. In other words, multiple applications, each independently utilizing vehicle data, can be simultaneously installed and operated on an onboard device connected to the in-vehicle network.

One aspect of the present disclosure is a data provision method for providing vehicle data to a requesting application, which is an application program that requests the vehicle data. The data provision method is applied to an onboard device that executes a transmission process to send a command used to acquire vehicle data to an in-vehicle network and provides the vehicle data acquired through the transmission process to one or more application programs.

In the data provision method, using one or more pieces of management information, the command indicated by the management information that meets the acquisition condition is extracted as a transmission target command, which is a command to be a transmission target in the transmission process. In the data provision method, routing information associating the transmission target command with the requesting application is generated. The management information indicates the type of command used to acquire the vehicle data, the requesting application, and the acquisition condition of the vehicle data. In the data provision method, the vehicle data acquired by executing the transmission process is provided to the requesting application using the routing information.

According to this method, the same effects as those of the aforementioned onboard device can be obtained.

One aspect of the present disclosure is a program. The program is executed in an onboard device that performs a transmission process to send a command used to acquire vehicle data to an in-vehicle network and provides the vehicle data acquired by the transmission process to one or more application programs. The program is executed to provide the vehicle data to a requesting application, which is an application program that requests the vehicle data.

The program causes the onboard device to execute a process that extracts the transmission target command using one or more pieces of management information and generates routing information. The management information indicates the type of command used to acquire the vehicle data, the requesting application, and the acquisition condition of the vehicle data. The transmission target command is a command to be a transmission target in the transmission process and is indicated by the management information that meets the acquisition condition. The routing information is information that associates the transmission target command with the requesting application.

The program causes the onboard device to execute a process that provides the vehicle data acquired by executing the transmission process to the requesting applications using the routing information.

By executing such a program, the same effects as those of the aforementioned onboard device can be obtained.

Hereinafter, embodiments of the present disclosure will be described with reference to the drawings.

### 1. Configuration

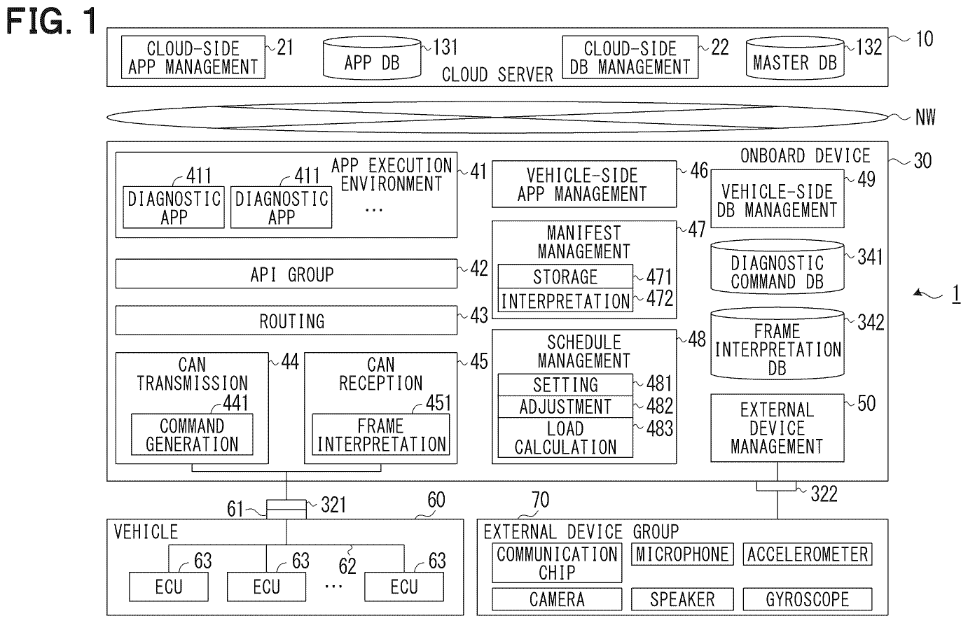

The data provision system 1 shown in FIG. 1 includes a cloud server 10 and an onboard device 30. In FIG. 1, one cloud server 10 and one onboard device 30 are illustrated as an example, but the data provision system 1 may include multiple cloud servers 10 and multiple onboard devices 30.

### (1-1. Cloud Server)

The cloud server 10 is configured to be accessible via a wide-area communication network NW. The cloud server 10 distributes various information necessary for executing diagnostic application programs (also referred to as diagnostic apps) to the onboard device 30. Diagnostic applications are applications that utilize vehicle data collected through diagnostic communication. Diagnostic communication, referred to as diagnostic communication, is a communication method that uses the in-vehicle network to acquire vehicle data necessary for fault diagnosis from an electronic control unit (ECU) 63. In this embodiment, a CAN bus 62 is used as the in-vehicle network. CAN stands for Controller Area Network and is a registered trademark.

Vehicle data is classified into multiple data types. The data types may include “Body Control and Powertrain,” “AD and ADAS,” “Driver Monitoring,” “Vehicle Body,” “Interior and Exterior Environment Control,” “Fuel and Exhaust,” “Media,” and “Diagnostic Trouble Codes (DTC).” “Body Control and Powertrain” may be referred to as a body control and powertrain system. “AD and ADAS” may be referred to as an AD and ADAS system. “Driver Monitoring” may be referred to as a driver monitoring system. “Vehicle Body” may be referred to as a vehicle body system. “Interior and Exterior Environment Control” may be referred to as an interior and exterior environment control system. “Fuel and Exhaust” may be referred to as a fuel and exhaust system. “Media” may be referred to as a media system.

The vehicle data for the Body Control and Powertrain category may include vehicle speed, body acceleration, body angular velocity, gear position, accelerator pedal position, brake pedal position, and brake pressure.

The vehicle data for the AD and ADAS category may include inter-vehicle distance, speed limit signs, stop sign detection, lane keep warning, preceding vehicle following, clearance sonar, and obstacle detection.

The vehicle data for the Driver Monitoring category may include distracted driving detection status, attention decline detection status, and driver abnormality detection status.

The vehicle data for the Vehicle Body category may include total mileage (i.e., odometer value, total traveled distance), Global Positioning System (GPS) location information, light status, door/window open/close status, door/window lock status, seatbelt status, airbag status, tire pressure, air conditioning operation status, and parking brake status.

The vehicle data for the Interior and Exterior Environment Control category may include interior and exterior temperature and air conditioning operation status.

The vehicle data for the Fuel and Exhaust category may include battery charge status, fuel tank capacity, remaining fuel amount, and average fuel consumption.

The vehicle data for the Media category may include media usage status, volume, Bluetooth (BT) connection status, and Data Communication Module (DCM) connection status. Bluetooth is a registered trademark.

The vehicle data for the DTC category may include a DTC list.

Vehicle data may be prioritized according to data types. The priority (also referred to as a priority degree) may be set as follows, for example. The priority setting according to data types is not limited to the following order and can be set arbitrarily.

The priority may be set as follows: Body Control and Powertrain>AD and ADAS>Driver Monitoring>Vehicle Body>Interior and Exterior Environment Control>Fuel and Exhaust>Media>DTC.

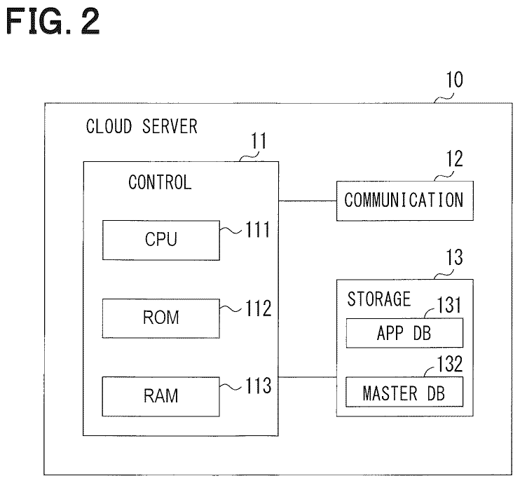

As shown in FIG. 2, the cloud server 10 includes a control unit 11, a communication unit 12, and a storage unit 13.

The control unit 11 includes a CPU 111, a ROM 112, and a RAM 113. Various functions of the control unit 11 are realized by the CPU 111 executing programs stored in a non-transitory tangible storage medium. In this example, the ROM 112 corresponds to the non-transitory tangible storage medium storing the programs. By executing these programs, methods corresponding to the programs are executed.

The communication unit 12 performs data communication with the onboard device 30 via wireless communication through the wide-area communication network NW.

The storage unit 13 includes an application database (also referred to an application DB) 131 and a master database (also referred to as a master DB) 132. The application DB 131 stores information related to one or more diagnostic applications. The master DB 132 stores information related to the CAN bus 62 of the vehicle 60 to which the onboard device 30 is connected.

### (1-2. Onboard Device)

As shown in FIG. 1, the onboard device 30 is used by being connected to a diagnostic port 61 provided in the vehicle 60. The onboard device 30 downloads and executes one or more diagnostic applications 411 from the cloud server 10.

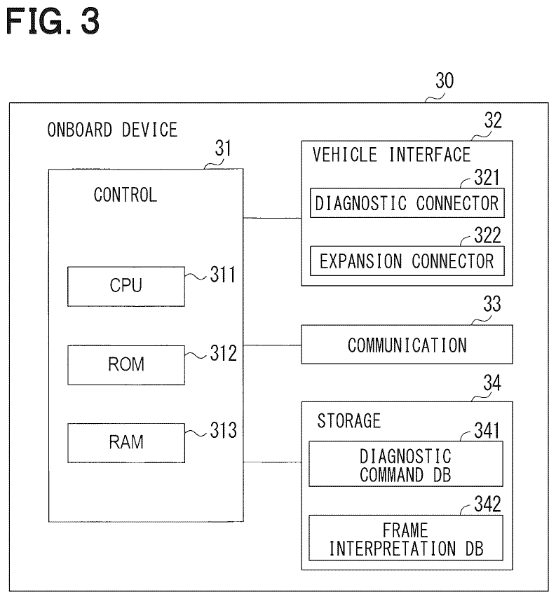

As shown in FIG. 3, the onboard device 30 includes a control unit 31, a vehicle interface (also referred to as a vehicle I/F) 32, a communication unit 33, and a storage unit 34.

The control unit 31 includes a CPU 311, a ROM 312, and a RAM 313. Various functions of the control unit 31 are realized by the CPU 311 executing programs stored in a non-transitory tangible storage medium. In this embodiment, the ROM 312 corresponds to the non-transitory tangible storage medium storing the programs. By executing these programs, methods corresponding to the programs are executed.

The vehicle I/F 32 includes a diagnostic connector 321 and an expansion connector 322.

As shown in FIG. 1, the diagnostic connector 321 is connected to the diagnostic port 61 (e.g., OBD port) provided in the vehicle 60. In other words, the onboard device 30 is connected to the CAN bus 62 of the vehicle 60 via the diagnostic port 61 connected to the diagnostic connector 321, and acquires various vehicle data held by the ECU 63 via diagnostic communication using the CAN bus 62.

The expansion connector 322 receives signals from an external device group 70 retrofitted to the vehicle 60. The external device group 70 may include communication chips (e.g., BLE, LTE, NFC), a camera, a microphone, a speaker, an accelerometer, a gyroscope, or the like. BLE stands for Bluetooth Low Energy. LTE stands for Long Term Evolution. NFC stands for Near Field Communication.

Returning to FIG. 3, the communication unit 33 performs data communication with the cloud server 10 connected to the wide-area communication network NW via wireless communication.

The storage unit 34 includes a diagnostic command database (referred to as a diagnostic command DB) 341 and a frame interpretation database (referred to as a frame interpretation DB) 342.

The diagnostic command DB 341 stores diagnostic command information acquired from the cloud server 10 via the communication unit 33. The frame interpretation DB 342 stores frame interpretation information acquired from the cloud server 10 via the communication unit 33. The diagnostic command information and frame interpretation information will be described later.

### 2. Functional Configuration

The functional configuration of the cloud server 10 and the onboard device 30 will be described.

### (2-1. Cloud Server)

As shown in FIG. 1, the cloud server 10 includes an application DB 131 and a master DB 132. The application DB 131 and the master DB 132 are configured on the storage unit 13.

The application DB 131 stores one or more diagnostic applications to be distributed to the onboard device 30 and manifests corresponding to each diagnostic application.

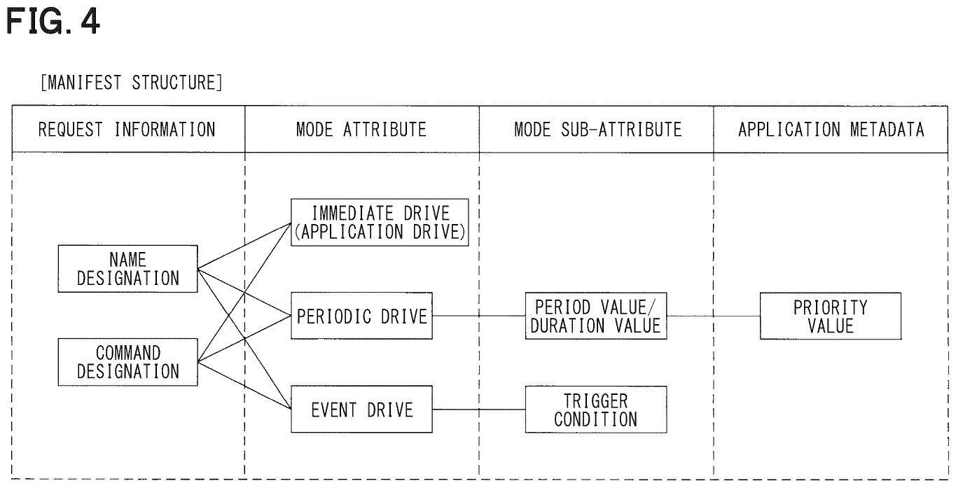

A manifest is an instruction document that describes one or more types of vehicle data used by the diagnostic application, associating each type of vehicle data with its acquisition conditions. The manifest is created by the application developer. The manifest is written in a format that can be understood even by application developers without specialized knowledge about vehicles. Specifically, as shown in FIG. 4, the manifest includes “request information” and “mode attribute.” Additionally, the manifest may include “mode sub-attribute” and “application metadata” (also referred to as app metadata) depending on the content of the “mode attribute.”

“Request information” specifies the types of vehicle data. When specifying the types of vehicle data, name designation and command designation can be used. Name designation is a method of specifying using standardized names that intuitively convey the meaning of the vehicle data and are commonly defined regardless of the vehicle model. Command designation is a method of specifying using the actual format (i.e., bit pattern) transmitted and received in vehicle diagnostic communication, which is uniquely defined for each vehicle model.

“Mode attribute” specify how to acquire the vehicle data indicated in the “request information.” The “mode attribute” include application drive (also referred to as application operation), periodic drive (also referred to as periodic operation), and event drive (also referred to as event operation). Application drive is a mode used to acquire specified vehicle data a limited number of times within a limited time according to instructions from the diagnostic application. Immediate drive is a type of application drive where the data is acquired only once immediately, and may also be referred to as immediate operation. In this embodiment, immediate drive is described as an example of application drive. Periodic drive is a mode used to repeatedly acquire specified vehicle data at a specified constant interval. Event drive is a mode used to acquire specified vehicle data triggered by a change in a signal detected when a specified event occurs.

“Mode sub-attribute” vary depending on the type of “mode attribute” and are set as needed. If the “mode attribute” is immediate drive, there may be no information set as “mode sub-attribute.” If the “mode attribute” is periodic drive, “mode sub-attribute” may include a period value representing the acquisition cycle of the vehicle data and a duration value representing the acquisition period of the vehicle data. If the “mode attribute” is event drive, “mode sub-attribute” may include trigger conditions. Trigger conditions define which signal state triggers the acquisition. Trigger conditions may use information obtained via the CAN bus 62, signals from the external device group 70, and information obtained by processing signals from the external device group 70 (e.g., differentiation, integration, smoothing).

“Application metadata” may include a priority value representing the priority of the vehicle data. The priority of vehicle data is used to determine which vehicle data acquisition to prioritize when multiple vehicle data acquisitions are requested at the same time and when it is difficult to process all requests.

The master DB 132 stores diagnostic command information and frame interpretation information.

Frame interpretation information defines the format of communication frames used on the CAN bus 62, bit assignments in each area of the frames, and units of values indicated in the assigned areas. Frame interpretation information is prepared for each vehicle model and is necessary for interpreting communication frames used in diagnostic communication.

Diagnostic command information includes a list of diagnostic commands usable on the CAN bus 62 and contains information related to name designation and command designation as described in the “request information” of the manifest. Diagnostic command information, like frame interpretation information, is prepared for each vehicle model.

The cloud server 10 includes a cloud-side application management unit 21 and a cloud-side DB management unit 22 as functions realized by the processing executed by the control unit 11.

The cloud-side application management unit 21 executes the distribution and deletion of diagnostic applications and other applications to the onboard device 30 and monitors the operation of the distributed diagnostic applications. The cloud-side application management unit 21 manages diagnostic applications stored in the application DB 131 and the manifests associated with the diagnostic applications by assigning application IDs. The cloud-side application management unit 21 may manage a diagnostic application in association with the business entity that developed the diagnostic application.

The cloud-side DB management unit 22 distributes diagnostic command information and frame interpretation information stored in the master DB 132 in response to requests from the onboard device 30 and update of the master DB 132. The cloud-side DB management unit 22 may be configured to identify the vehicle model from the vehicle identification number (VIN).

### (2-2. Onboard Device)

The onboard device 30 includes a diagnostic command DB 341 and a frame interpretation DB 342. The diagnostic command DB 341 and the frame interpretation DB 342 are configured on the storage unit 34.

The diagnostic command DB 341 stores diagnostic command information applicable to the vehicle model of the vehicle 60 (referred to as a mounted vehicle, an equipped vehicle) to which the onboard device 30 is attached.

The frame interpretation DB 342 stores frame interpretation information applicable to the vehicle model of the mounted vehicle 60.

The onboard device 30 includes, as functions realized by the processing executed by the control unit 31, an application execution environment 41, an API group 42, a routing unit 43, a CAN transmission unit 44, a CAN reception unit 45, a vehicle-side application management unit 46, a manifest management unit 47, a schedule management unit 48, a vehicle-side DB management unit 49, and an external device management unit 50.

The external device management unit 50 manages the external device group 70 connected to the expansion connector 322 of the onboard device 30. The external device management unit 50 monitors signals input from each external device belonging to the external device group 70. The external device management unit 50 has a function to notify the schedule management unit 48 of the occurrence of an event when the monitored signal satisfies the trigger conditions notified by the schedule management unit 48. The external device management unit 50 may also have a function to notify the schedule management unit 48 of a hardware configuration change when detecting a change in the external device group 70 connected to the expansion connector 322 compared to the previous startup during the startup of the onboard device 30.

The vehicle-side DB management unit 49 acquires diagnostic command information and frame interpretation information suitable for the mounted vehicle 60 from the cloud server 10 during the initial connection of the onboard device 30 to the mounted vehicle 60 and stores them in the diagnostic command DB 341 and the frame interpretation DB 342.

The application execution environment 41 includes an OS and middleware, providing an execution environment for diagnostic applications distributed from the cloud server 10.

The vehicle-side application management unit 46 acquires diagnostic applications 411 from the cloud server 10 via the wide-area communication network NW and deploys (i.e., installs, configures) the acquired diagnostic applications 411 in the application execution environment 41 for execution. The vehicle-side application management unit 46 also monitors the operation of the deployed diagnostic applications 411 and performs deletion of the deployed diagnostic applications 411. Furthermore, the vehicle-side application management unit 46 provides the manifest distributed from the cloud server 10 along with the diagnostic applications 411 to the manifest management unit 47. The vehicle-side application management unit 46 may have a function to notify the schedule management unit 48 of software configuration changes each time a diagnostic application is deployed or deleted.

The API group 42 is a collection of application programming interfaces (APIs) that provide various functions to the diagnostic applications 411 executed in the application execution environment 41. The API group 42 includes at least an API that provides the function to acquire vehicle data via the CAN bus 62 of the mounted vehicle 60.

The routing unit 43 has routing information notified by the schedule management unit 48. The routing information associates the diagnostic applications 411 (also referred to as requesting applications or request source applications) that request vehicle data with the diagnostic commands sent to the CAN bus 62 according to the requests. The routing unit 43 distributes, by sending diagnostic commands via the CAN transmission unit 44, the vehicle data received by the CAN reception unit 45 to the requesting applications by referring to the routing information.

In other words, since CAN is a communication method that does not perform session management to identify communication partners, when there are multiple requesting applications, it is not possible to determine which diagnostic application 411 the received frame is based on. Therefore, the routing unit 43 ensures that the vehicle data acquired from the CAN bus 62 via the CAN reception unit 45 correctly reaches each requesting application by referring to the routing information that associates the requesting applications with the command IDs.

The manifest management unit 47 includes a storage unit 471 and an interpretation unit 472.

The storage unit 471 stores the manifests provided by the vehicle-side application management unit 46.

The interpretation unit 472 interprets the content of the manifests stored in the storage unit 471 to extract and generate information necessary for setting the command management table and provides it to the schedule management unit 48. Specifically, the interpretation unit 472 identifies the vehicle data from the “request information” of the manifest and extracts the command IDs of the commands used to acquire the identified vehicle data from the diagnostic command information. The interpretation unit 472 extracts the content of the “mode attribute” and “mode sub-attribute” of the manifest as acquisition conditions for the vehicle data. The interpretation unit 472 extracts the content of the “application metadata” of the manifest as priority values representing the transmission priority. Instead of using the priority values set in the “application metadata,” the interpretation unit 472 may automatically set priority values based on the “mode attribute” and “mode sub-attribute” (i.e., acquisition conditions for the vehicle data) of the manifest, for example, as follows:
“Immediate drive or event drive”<“Periodic drive: long cycle”<“Periodic drive: short cycle”.

In other words, the priority of periodic drive commands may be set higher than that of immediate drive commands and event drive commands, and among periodic drive commands, the priority of shorter cycle commands may be set higher. However, the priority order is not limited to the above description and can be set arbitrarily.

Additionally, instead of using the priority values set in the “application metadata,” the interpretation unit 472 may use priority values set according to the data types of the vehicle data identified from the “request information” of the manifest. The interpretation unit 472 may also combine the priority values set based on the acquisition conditions of the vehicle data and the priority values set according to the data types.

The schedule management unit 48 includes a setting unit 481, an adjustment unit 482, and a load calculation unit 483.

The setting unit 481 adds management information that indicates the acquisition conditions of the vehicle data to the command management table based on the interpretation results of the manifest by the interpretation unit 472. The command management table is a table that indicates information used to manage the transmission timing of diagnostic commands.

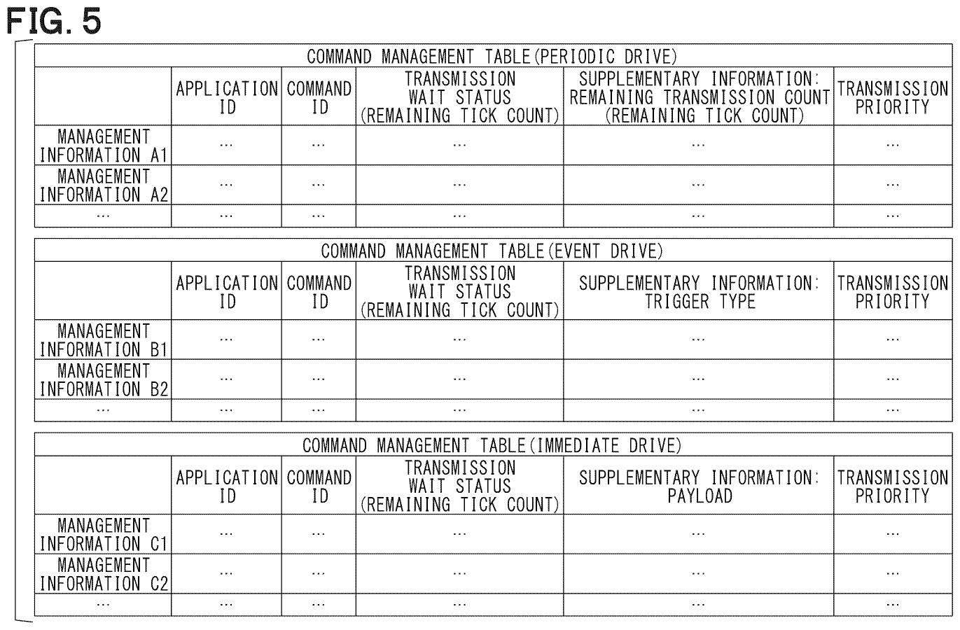

As shown in FIG. 5, the management information set in the command management table includes “Application ID,” “Command ID,” “Transmission Wait Status,” “Supplementary Information,” and “Transmission Priority.” “Transmission Wait Status” may be referred to as transmission pending status. The command management table is generated for each type of “mode attribute,” and the content of “Supplementary Information” differs for each “mode attribute.”

“Application ID” is information that identifies the requesting application and is assigned when the diagnostic application is deployed by the vehicle-side application management unit 46.

“Command ID” is information that identifies the diagnostic command used to acquire the vehicle data indicated in the “request information” of the manifest.

“Transmission Wait Status” indicates the remaining number of ticks until transmission. A tick is the execution cycle of the diagnostic command transmission process, set to, for example, 100 ms (microseconds). The remaining number of ticks is decremented with each tick, and the management information with a remaining tick count of 0 is processed in the next tick.

However, if the “mode attribute” is periodic drive, the “Transmission Wait Status” is preset to the number of ticks corresponding to the period value indicated in the “mode sub-attribute” each time the command is transmitted. As a result, in the case of periodic drive, the command transmission is repeated at intervals corresponding to the period value.

If the “mode attribute” is event drive, the “Transmission Wait Status” is normally set to an invalid value indicating no request. The “Transmission Wait Status” is set to 0 when the specified trigger condition is satisfied. After the command is transmitted, it is set back to the invalid value. The invalid value may be, for example, a value padded with all bits set to 1.

If the “mode attribute” is immediate drive, the “Transmission Wait Status” is normally set to an invalid value and is set to 0 when a request from the diagnostic application 411 occurs. After the command is transmitted, it is set back to the invalid value. When the “Transmission Wait Status” is set to an invalid value, it is not decremented with each tick, and the invalid value is maintained.

If the “mode attribute” is periodic drive, “Supplementary Information” may include “Remaining Transmission Count.” “Remaining Transmission Count” is set to a value indicating the remaining number of ticks for the effective period if the “mode sub-attribute” of the manifest include information on the effective period. If the effective period is unlimited, “Remaining Transmission Count” is set to an invalid value. The remaining number of ticks for “Remaining Transmission Count” is decremented with each tick. However, if set to an invalid value, it is not decremented with each tick, and the invalid value is maintained. Management information with a “Remaining Transmission Count” of tick count of 0 is deleted from the command management table.

If the “mode attribute” is event drive, “Supplementary Information” may include “Trigger Type.” “Trigger Type” sets a trigger condition, which is a condition for notifying the occurrence of an event. The setting unit 481 notifies the external device management unit 50 and the CAN reception unit 45 of the trigger condition according to the content of the “Trigger Type.”

If the “mode attribute” is immediate drive, “Supplementary Information” may include “Payload.” “Payload” is the command itself, indicated in the bit format to be written into the CAN frame payload.

“Transmission Priority” is set with a priority value. The priority value is used to determine which diagnostic command to prioritize when it is difficult to process all transmission candidates in the next tick due to reasons such as overload or the like. Here, the larger the priority value, the higher the priority. If a priority value is set in the “application metadata” of the manifest, this priority value may be used. If no priority value is set, it may be considered the lowest priority.

The adjustment unit 482 refers to the command management table to determine the management information to be processed in the next tick, i.e., the diagnostic commands to be transmitted, and notifies the CAN transmission unit 44. The determination of the diagnostic commands to be transmitted takes into account the turnaround time of each diagnostic command, the traffic on the CAN bus 62, and the transmission priority of the diagnostic commands.

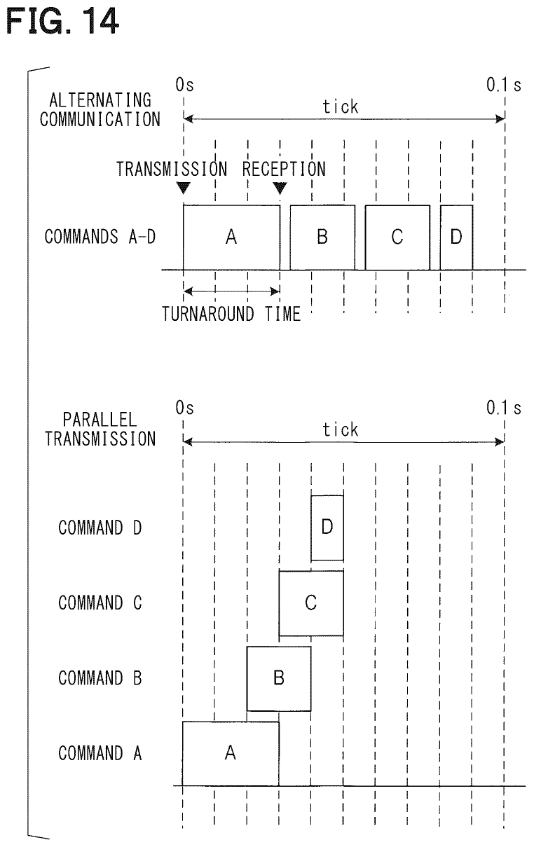

In diagnostic communication, if parallel transmission of commands is prohibited and alternating communication of commands is required, the number of commands that can be transmitted per tick can be estimated from the turnaround time. Alternating communication, as shown in the upper part of FIG. 14, is a method where the next command is transmitted after receiving the response to the previous command. Parallel transmission, as shown in the lower part of FIG. 14, is a method where the next command is transmitted without waiting for the response to the previous command.

Traffic is the ratio of usage of the CAN bus 62. The higher the traffic, the longer the turnaround time, and the fewer commands that can be transmitted per tick. Additionally, the upper limit of allowable traffic (allowable value) on the CAN bus 62 may be set for each vehicle model.

The load calculation unit 483 measures the turnaround time used in the processing by the adjustment unit 482 after the initialization process at the startup of the onboard device 30. The turnaround time measurement involves the CAN transmission unit 44 sending a command to the CAN bus 62 and the CAN reception unit 45 measuring the time until a response is received. This measurement is repeated for multiple commands. The load calculation unit 483 may calculate the average value of the measured turnaround times. The load calculation unit 483 stores either or both the turnaround time measured for each command and the average turnaround time in the diagnostic command DB 341. Instead of the average turnaround time, a value with a safety margin added to the average turnaround time may be used.

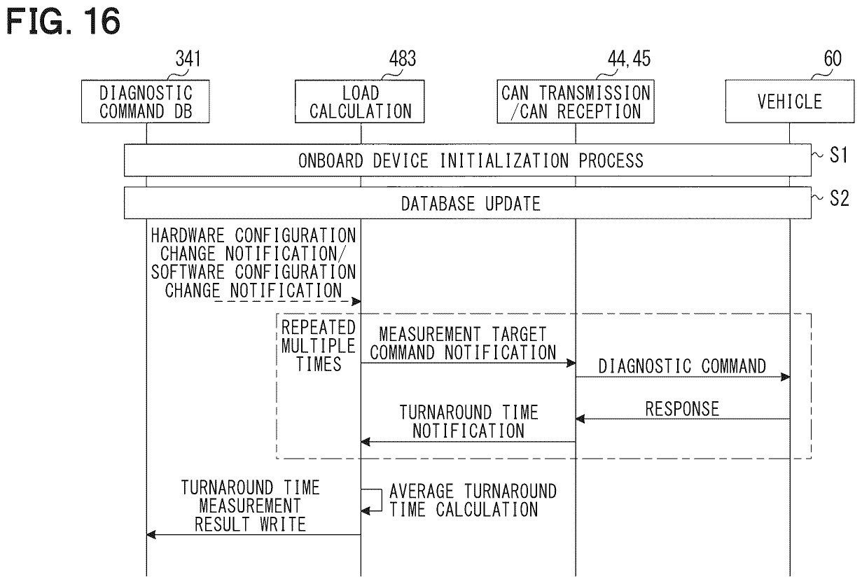

The load calculation unit 483 may measure the turnaround time each time the onboard device 30 starts. Additionally, as shown by the dotted line in FIG. 16, the load calculation unit 483 may measure the turnaround time when it receives a notification of a hardware configuration change from the external device management unit 50. The load calculation unit 483 may also measure the turnaround time when it receives a notification of a software configuration change from the vehicle-side application management unit 46.

The CAN transmission unit 44 includes a command generation unit 441. The command generation unit 441 generates diagnostic commands by referring to the diagnostic command DB 341 according to the instructions from the adjustment unit 482 of the schedule management unit 48. The command generation unit 441 further generates CAN frames with the diagnostic commands stored in the payload and stores them in the transmission buffer. The CAN transmission unit 44 sends the CAN frames stored in the transmission buffer to the CAN bus 62 via the diagnostic connector 321.

The CAN reception unit 45 includes a frame interpretation unit 451. The CAN reception unit 45 stores the CAN frames (i.e., responses to diagnostic commands) received from the CAN bus 62 via the diagnostic connector 321 in the reception buffer. The frame interpretation unit 451 interprets the content of the received CAN frames (received frames) by referring to the frame interpretation information stored in the frame interpretation DB 342. The frame interpretation unit 451 converts the vehicle data indicated in the payload of the received frames, which is described in a format unique to the vehicle 60, into a format understandable by the requesting application. The frame interpretation unit 451 then provides the interpreted and converted vehicle data to the routing unit 43 along with the command ID of the transmitted diagnostic command.

The CAN reception unit 45 has a function to monitor vehicle data received periodically. The CAN reception unit 45 has a function to notify the schedule management unit 48 of the occurrence of an event when the monitored signal satisfies the trigger conditions notified by the schedule management unit 48. The CAN reception unit 45 also has a function to measure the turnaround time, which is the time from when a command is transmitted by the CAN transmission unit 44 to when the response to that command is received by the CAN reception unit 45, and to notify the load calculation unit 483.

The routing unit 43 provides the vehicle data supplied by the CAN reception unit 45 to the requesting application according to the routing information notified by the adjustment unit 482 of the schedule management unit 48.

### 3. Operation

### (3-1. Operation at Power-On of the Onboard Device)

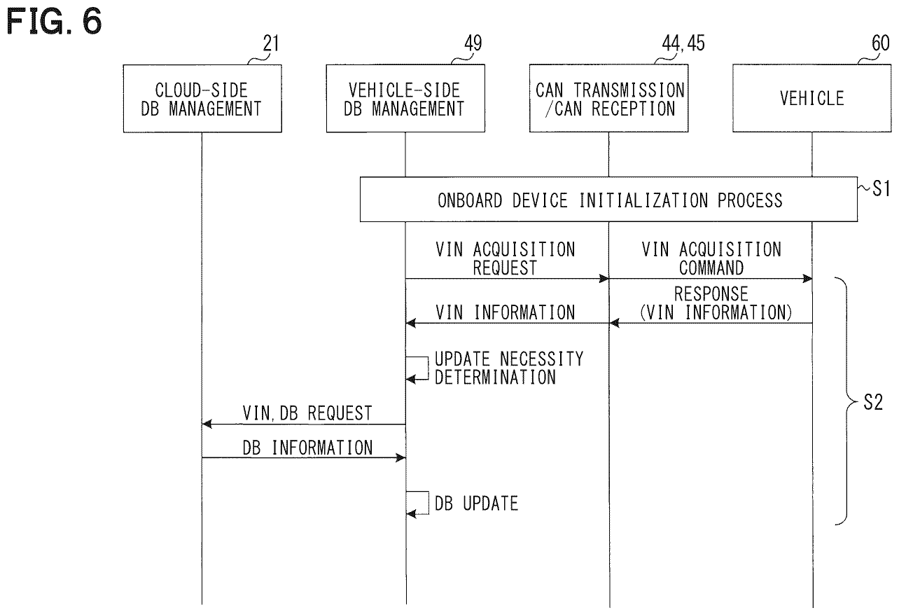

The operation of each part of the system when powering on the onboard device 30 will be described with reference to the sequence diagram shown in FIG. 6.

As shown in FIG. 6, when the onboard device 30 is powered on, the onboard device 30 executes a process to initialize the onboard device 30 (onboard device initialization process) S1. The onboard device initialization process S1 enables the onboard device 30 to perform diagnostic communication using standard commands.

The vehicle-side DB management unit 49 sends a VIN acquisition command, which is one of the standard commands, to the CAN bus 62 via the CAN transmission unit 44 and receives the response via the CAN reception unit 45 to acquire VIN information from the vehicle 60.

The vehicle-side DB management unit 49 determines whether to update the diagnostic command DB 341 and the frame interpretation DB 342 using the acquired VIN information. Specifically, if VIN-related information is not stored in the diagnostic command DB 341 and the frame interpretation DB 342, it is determined that an update is necessary. VIN-related information is diagnostic command information and frame interpretation information associated with the acquired VIN information. If VIN-related information is already stored in the diagnostic command DB 341 and the frame interpretation DB 342, it is determined that an update is not necessary.

For example, if the onboard device 30 is installed in a vehicle for the first time, it is determined that an update is necessary. Additionally, if the onboard device 30 is removed from a first vehicle 60 and installed in a second vehicle 60, and the VIN-related information of the first vehicle 60 remains in the diagnostic command DB 341 and the frame interpretation DB 342, it is determined that an update is necessary when the VIN information of the second vehicle 60 is acquired.

If it is determined that an update is not necessary, the vehicle-side DB management unit 49 terminates the operation.

If it is determined that an update is necessary, the vehicle-side DB management unit 49 sends a data acquisition request to the cloud server 10 along with the acquired VIN information to obtain VIN-related information corresponding to the vehicle model of the mounted vehicle 60 from the cloud server 10. At this time, the cloud-side DB management unit 22 of the cloud server 10 identifies the vehicle model from the VIN information indicated in the data acquisition request, reads the VIN-related information corresponding to the identified vehicle model from the master DB 132, and replies to the onboard device 30.

The vehicle-side DB management unit 49 updates the diagnostic command DB 341 and the frame interpretation DB 342 with the VIN-related information received from the cloud server 10. The updated VIN-related information is stored in association with the VIN information.

The series of processes executed after the onboard device initialization process S1 described with reference to FIG. 6 will be referred to as the database update process S2.

### (3-2. Turnaround Time Measurement)

The operation of each part of the system when measuring the turnaround time of diagnostic commands used by the onboard device 30 will be described with reference to the sequence diagram shown in FIG. 16.

As shown in FIG. 16, after the onboard device initialization process S1 and the database update process S2 described earlier with reference to FIG. 6 are completed, the load calculation unit 483 reads multiple pre-specified commands from the diagnostic command DB 341 for turnaround time measurement. One of the read commands is selected as the measurement target command, and the CAN transmission unit 44 is notified to measure the turnaround time using the selected measurement target command.

The CAN transmission unit 44 sends the measurement target command to the CAN bus 62. At this time, the CAN reception unit 45 starts measuring the turnaround time. When the CAN reception unit 45 receives a response from the CAN bus 62, it stops measuring the turnaround time and sends the measurement result to the load calculation unit 483.

The load calculation unit 483 performs the same process for all the commands read from the diagnostic command DB 341 to obtain the turnaround time for each command. After the transmission of all the specified commands is completed, the load calculation unit 483 calculates the average turnaround time. Furthermore, the load calculation unit 483 stores the measurement results of the turnaround time for individual commands and the calculated average turnaround time in the diagnostic command DB 341 so that they can be used in the processing by the adjustment unit 482.

The load calculation unit 483 may measure the turnaround time each time the onboard device 30 starts. Additionally, the load calculation unit 483 may measure the turnaround time when it receives a notification of a hardware configuration change from the external device management unit 50 or a notification of a software configuration change from the vehicle-side application management unit 46.

### (3-3. Application Distribution/Command Management Table Setting)

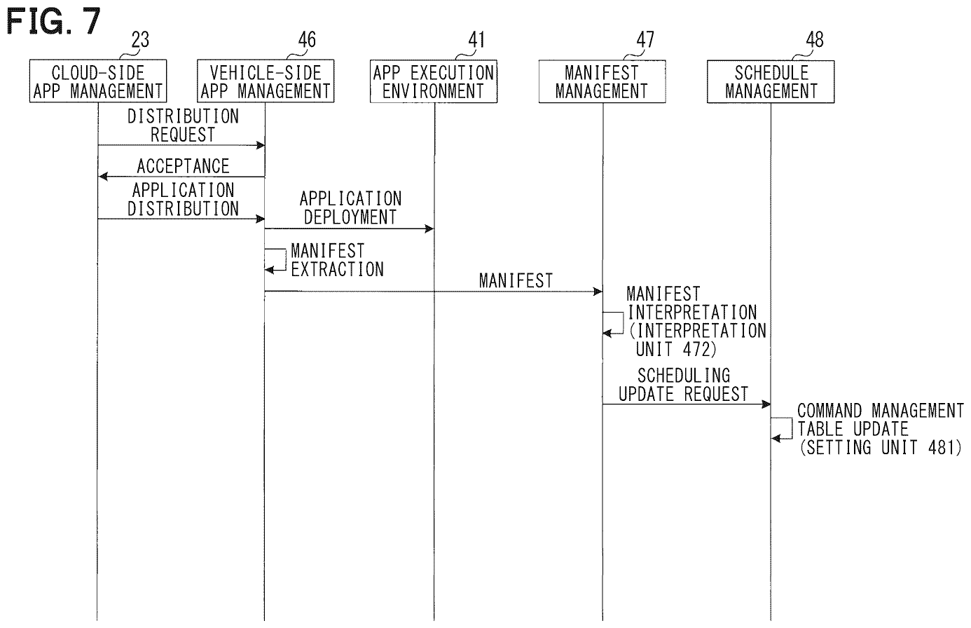

The operation of each part of the system during the distribution of diagnostic applications from the cloud server 10 to the onboard device 30 will be described with reference to the sequence diagram shown in FIG. 7.

As shown in FIG. 7, if a diagnostic application waiting for distribution is stored in the application DB 131, the cloud-side application management unit 21 of the cloud server 10 sends a distribution request to the onboard device 30 to request acceptance of the distribution of the diagnostic application.

When the vehicle-side application management unit 46 of the onboard device 30 receives the distribution request, it determines whether to accept the distribution according to the information indicated in the distribution request. If accepted, it sends an acceptance notification to the cloud server 10. The information used to determine whether to accept the distribution may include the memory capacity required to store the program, the processing capability of the CPU required to execute the application, and the memory capacity required for the application.

The cloud-side application management unit 21 distributes the diagnostic applications and manifests stored in the application DB 131 to the onboard device 30 that sent the acceptance notification. At this time, the cloud-side application management unit 21 may register information related to the onboard device 30 (e.g., VIN information of the vehicle in which the onboard device 30 is installed) in the application DB 131.

When the vehicle-side application management unit 46 receives the diagnostic applications from the cloud server 10, it deploys the received diagnostic applications 411 in the application execution environment 41 for execution. Additionally, the vehicle-side application management unit 46 provides the manifest attached to the diagnostic applications 411 to the manifest management unit 47. The deployed diagnostic applications 411 are assigned an application ID, which is also associated with the manifests provided to the manifest management unit 47.

The manifest management unit 47 stores the manifests provided by the vehicle-side application management unit 46 in the storage unit 471 and interprets the content of the manifests with the interpretation unit 472 to extract the information necessary for registration in the command management table. Specifically, the interpretation unit 472 extracts the application ID associated with the manifest, the command ID, the vehicle data acquisition conditions (i.e., “mode attribute” and “mode sub-attribute”), and the transmission priority, and provides them to the schedule management unit 48.

If the “mode attribute” of the manifest is periodic drive and the period value indicated in the “mode sub-attribute” is shorter than the tick, the manifest management unit 47 may notify the vehicle-side application management unit 46 that it is not possible to acquire the vehicle data at the requested timing. Upon receiving the notification, the vehicle-side application management unit 46 may delete the corresponding diagnostic application and notify the cloud server 10 of the deletion along with the reason.

The setting unit 481 of the schedule management unit 48 updates the command management table using the information (update information) provided by the interpretation unit 472 of the manifest management unit 47.

As shown in FIG. 5, the command management table is prepared for each type of “mode attribute.” The command management table is updated by adding new management information (i.e., application ID, command ID, transmission wait status, supplementary information, transmission priority).

### (3-4. Transmission Wait Status Update)

The operation of the adjustment unit 482 of the schedule management unit 48 in updating the “Transmission Wait Status” in the command management table will be described.

The adjustment unit 482 decrements both the remaining tick count indicated in the “Transmission Wait Status” and the remaining tick count indicated in the “Supplementary Information (i.e., Remaining Transmission Count)” for the management information registered in the command management table for periodic drive each time the schedule adjustment process, described later, is completed. However, for management information with a remaining tick count of 0 in the “Transmission Wait Status” before decrementing, the adjustment unit 482 presets the remaining tick count to a value corresponding to the period value instead of decrementing it.

If the remaining tick count in the “Supplementary Information” becomes 0 as a result of decrementing the remaining tick count in the “Supplementary Information”, the adjustment unit 482 deletes that management information from the command management table.

When the adjustment unit 482 receives a trigger signal from the external device management unit 50 or the CAN reception unit 45, it sets the “Transmission Wait Status” to 0 for the management information corresponding to the received trigger signal in the command management table for event drive.

When the adjustment unit 482 receives an immediate acquisition request for vehicle data from a diagnostic application via the API group 42, it sets the “Transmission Wait Status” to 0 for the management information corresponding to the received immediate acquisition request in the command management table for immediate drive.

### (3-5. Schedule Adjustment)

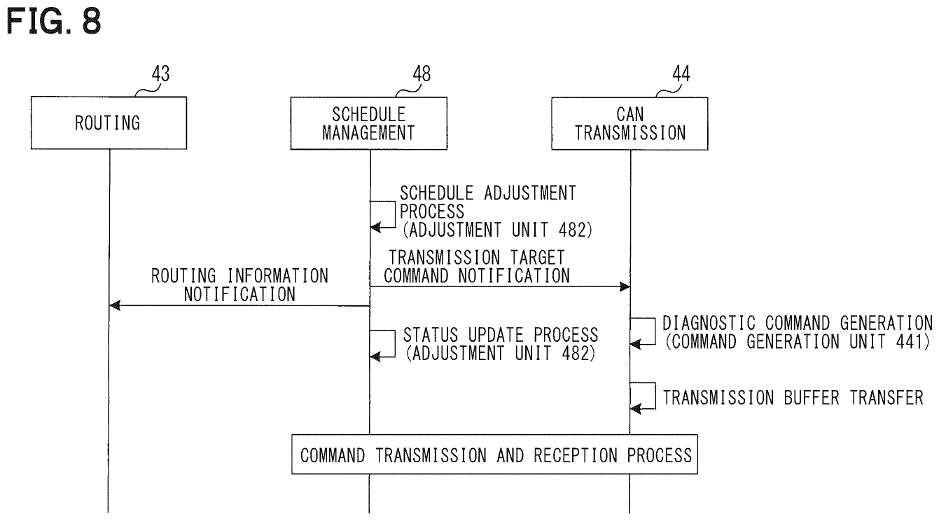

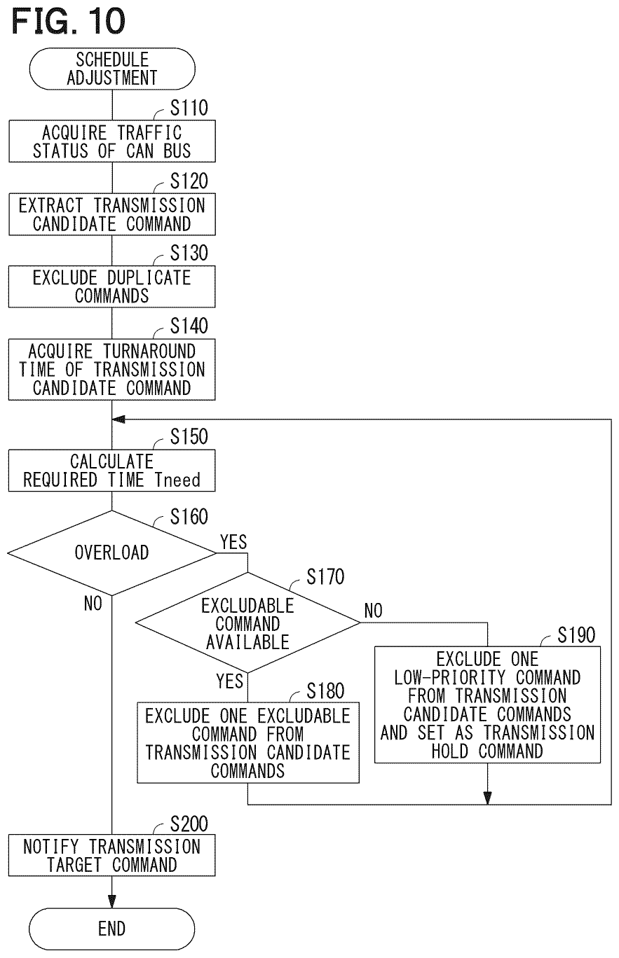

The schedule adjustment process by which the adjustment unit 482 of the schedule management unit 48 determines the diagnostic commands to be transmitted at the next tick using the command management table will be described with reference to the sequence diagram in FIG. 8 and the flowchart in FIG. 10.

The adjustment unit 482 executes the schedule adjustment process for each tick.

When the schedule adjustment process starts, the adjustment unit 482 first acquires the traffic status of the CAN bus 62 in S110. The traffic status may be obtained using information from an ECU 63 that measures the traffic of the CAN bus 62 or by separately measuring it in the onboard device 30. Alternatively, static traffic information (also referred to as static traffic information) registered in the system in advance may be used. Static traffic information may be, for example, an average value measured for each vehicle model or a value with a safety margin added to the average value. Static traffic information may also be included in the information stored in the diagnostic command DB 341. Furthermore, static traffic information may be used when dynamic traffic information, which represents the real-time traffic status measured at that moment, cannot be obtained from the ECU 63 or the onboard device 30.

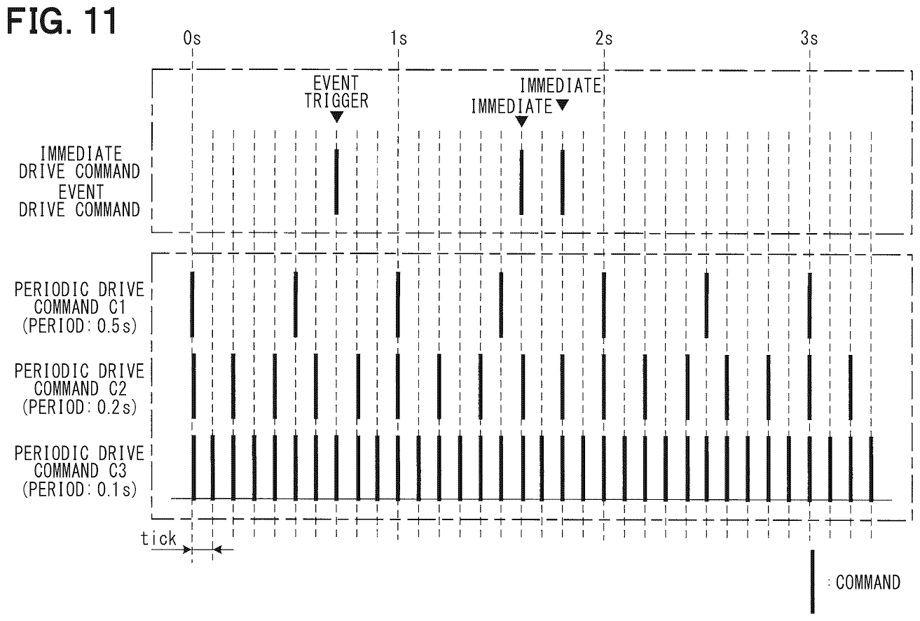

In S120, the adjustment unit 482 refers to the “Transmission Wait Status” in the command management table and extracts all management information with a remaining tick count of 0, i.e., all management information to be processed in the next tick, as transmission candidate commands. The transmission candidate commands (i.e., diagnostic command transmission requests) extracted for each tick based on the command management table are illustrated in FIG. 11. FIG. 11 shows a case where there are three periodic drive commands C1 to C3, one event drive command, and two immediate drive commands. The periodic drive command C1 is processed at a period of 0.5 seconds (i.e., 5 ticks), the periodic drive command C2 is processed at a period of 0.2 seconds (i.e., 2 ticks), and the periodic drive command C3 is processed at a period of 0.1 seconds (i.e., 1 tick). FIG. 11 shows the transmission schedule of diagnostic commands before load adjustment.

In S130, the adjustment unit 482 checks for duplicate management information with the same command ID among the extracted transmission candidate commands. If duplicate management information exists, the adjustment unit 482 excludes the duplicate management information, leaving only one management information. The adjustment unit 482 also generates routing information to be provided to the routing unit 43. The routing information associates the command ID indicated by the transmission candidate commands with the application ID of the requesting application based on the information shown in the command management table. In the routing information, each command ID is associated with one or more application IDs.

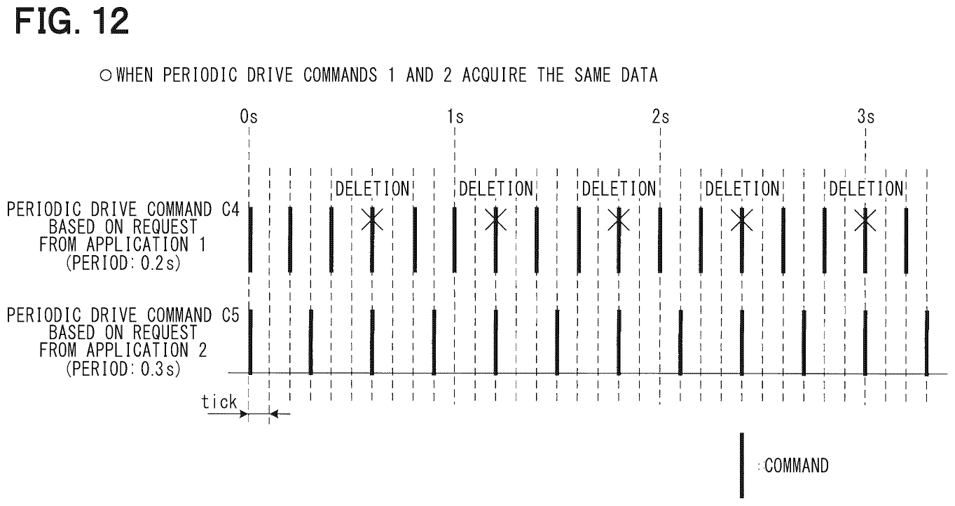

For example, as shown in FIG. 12, if periodic drive commands C4 and C5 are set to acquire the same vehicle data at different intervals from multiple diagnostic applications 411, the requests from both applications may overlap in the same tick. In such cases, instead of transmitting both overlapping periodic drive commands C4 and C5, the adjustment is made to transmit only one (e.g., command C5 in FIG. 12). However, since CAN does not perform session management, the correspondence between the acquired vehicle data and the requesting application is unclear. Therefore, routing information is used to ensure that the acquired vehicle data is correctly provided to the requesting application.

In S140, the adjustment unit 482 acquires the turnaround time for all transmission candidate commands. As described earlier, the turnaround time for each command may be the values measured at the startup of the onboard device 30 and stored in the diagnostic command DB 341. Alternatively, the average turnaround time calculated from the measured values, or the design values, may be used.

In S150, the adjustment unit 482 calculates the required time Tneed to transmit all transmission candidate commands using alternating communication. The required time Tneed is the sum of the turnaround times for all transmission candidate commands. However, the turnaround time may be corrected to be longer according to the traffic status acquired in S110, with higher traffic resulting in longer turnaround times.

In S160, the adjustment unit 482 determines whether the processing in the next tick will result in overload. Overload occurs when the required time Tneed calculated in S150 is greater than the tick or when transmitting the transmission candidate commands would cause the estimated traffic on the CAN bus 62 to exceed the allowable value. If the adjustment unit 482 determines that there is no overload in S160, the process proceeds to S200. If overload is determined, the process proceeds to S170.

In S170, the adjustment unit 482 determines whether there are any excludable commands among the transmission candidate commands. For example, transmission candidate commands with a priority value below the excludable threshold may be considered excludable commands.

The adjustment unit 482 proceeds to S180 if there are excludable commands among the transmission candidate commands. If there are no excludable commands, the process proceeds to S190.

In S180, the adjustment unit 482 excludes at least one of the excludable commands from the transmission candidate commands and also excludes the information related to the excluded transmission candidate commands from the routing information. The process then returns to S150. The adjustment unit 482 may notify the requesting application of the excluded transmission candidate command that the request was not processed.

In S190, the adjustment unit 482 excludes at least one command with the lowest priority value or a command with a period value of a predetermined value (e.g., 10 ticks) or more from the transmission candidate commands and designates it as a transmission hold command. The adjustment unit 482 also excludes the information related to the transmission hold command from the routing information. Furthermore, the adjustment unit 482 increases the remaining tick count of the “Transmission Wait Status” of the transmission hold command in the command management table by 1 so that the transmission hold command is extracted as a transmission candidate command in the next tick. The number of ticks to increase the remaining tick count is not limited to 1 and may be a randomly selected number within a certain range. The certain range may be set to be larger during higher traffic conditions on the CAN bus 62.

In S200, the adjustment unit 482 notifies the CAN transmission unit 44 of the transmission candidate commands as the transmission target commands and notifies the routing unit 43 of the routing information, thereby ending the process.

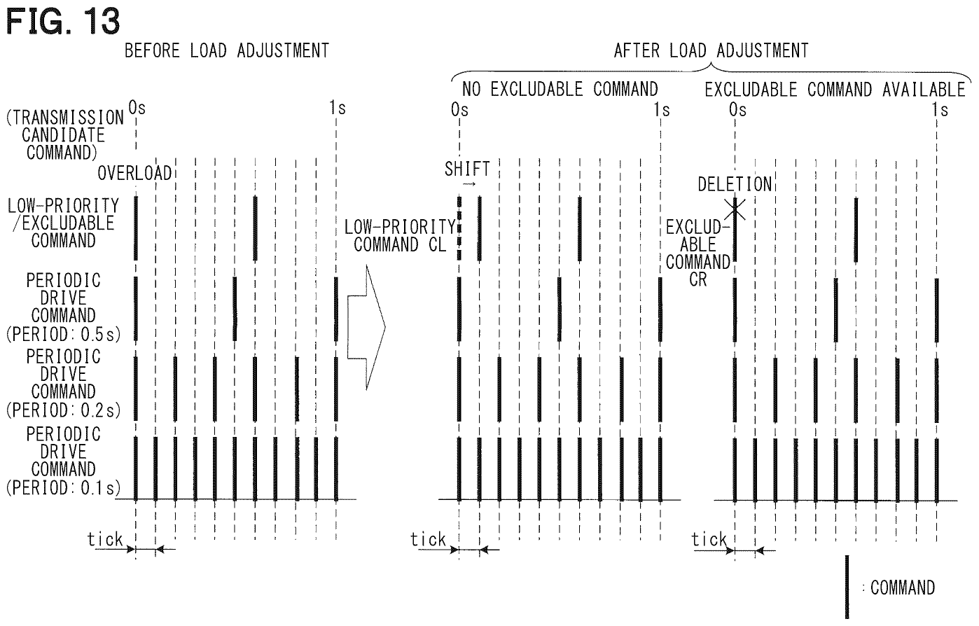

As shown in FIG. 13, if overload occurs, the load on the CAN bus 62 is adjusted by excluding the excludable command CR if it is included in the transmission candidate commands. If no excludable command CR is included, the load on the CAN bus 62 is adjusted by ensuring that the low-priority command CL or the command with a period value of a predetermined value or more among the transmission candidate commands is transmitted in subsequent ticks.

As shown in FIG. 8, when the CAN transmission unit 44 receives the notification of the transmission target commands, it retrieves the bit pattern representing the diagnostic command from the diagnostic command DB 341 according to the command ID indicated in the management information of the transmission target commands. The CAN transmission unit 44 generates a transmission frame (i.e., CAN frame) with the retrieved bit pattern set in the payload and transfers it to the transmission buffer.

The CAN frames transferred to the transmission buffer are transmitted and received according to the diagnostic communication transmission and reception process on the CAN bus 62.

### (3-6. Response Reception)

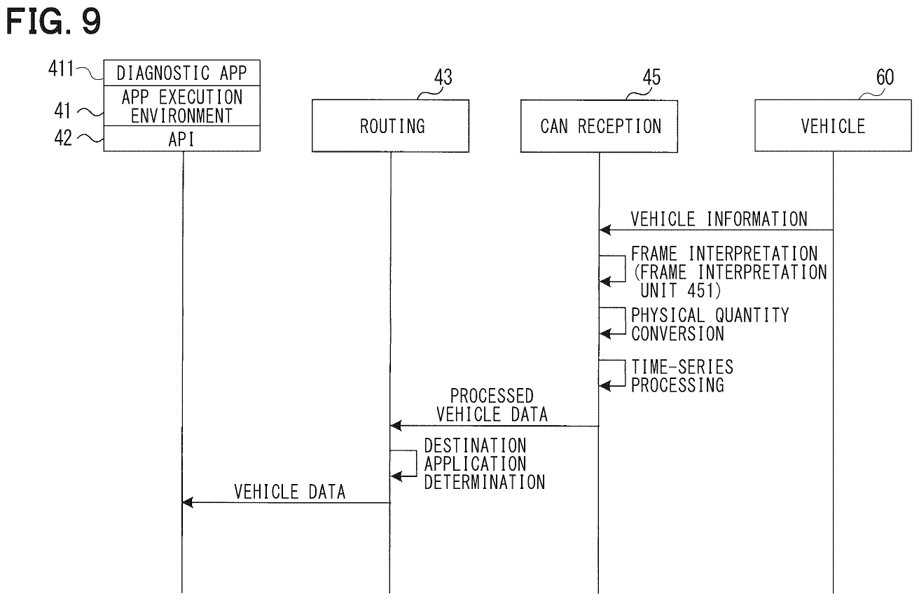

The operation when the onboard device 30 transmits a CAN frame containing a diagnostic command and receives a CAN frame containing a response (i.e., vehicle data) from the vehicle 60 will be described with reference to the sequence diagram shown in FIG. 9.

As shown in FIG. 9, when the CAN reception unit 45 receives a CAN frame indicating a response to a diagnostic command, the frame interpretation unit 451 analyzes the bits in the payload of the received CAN frame. The frame interpretation information stored in the frame interpretation DB 342 is used for the bit analysis. The vehicle data obtained from the bit analysis may represent some state (e.g., switch on/off) or a sampling value of an analog signal (i.e., a physical quantity). If the vehicle data represents a physical quantity, the frame interpretation unit 451 may convert the obtained physical quantity into a predetermined unit (e.g., a unit used by the requesting application) or perform time-series processing on the obtained physical quantity. Time-series processing includes operations such as differentiation, integration, and smoothing applied to the obtained vehicle data.

The CAN reception unit 45 notifies the routing unit 43 of the vehicle data processed by the frame interpretation unit 451 along with the command ID representing the diagnostic command sent to acquire that vehicle data.

Based on the command ID and vehicle data notified by the CAN reception unit 45, the routing unit 43 refers to the routing information notified by the schedule management unit 48 to identify the application ID corresponding to the command ID. Furthermore, the routing unit 43 notifies the requesting application indicated by the application ID of the vehicle data via the application execution environment 41.

In this embodiment, the CAN transmission unit 44 and the CAN reception unit 45 correspond to a data acquisition unit in the present disclosure. The application execution environment 41 corresponds to an application execution unit in the present disclosure. The vehicle-side DB management unit 49 corresponds to a peripheral information acquisition unit in the present disclosure. The diagnostic command information and frame interpretation information correspond to the peripheral information in the present disclosure.

According to the embodiments described in detail above, the following effects are achieved.

In the data provision system 1, the onboard device 30 generates management information to be registered in the command management table according to the manifest distributed along with the diagnostic applications 411 from the cloud server 10. By using the management information registered in the command management table, the onboard device 30 adjusts the timing for processing vehicle data acquisition requests from multiple diagnostic applications.

Therefore, according to the onboard device 30, it is possible to operate multiple diagnostic applications utilizing diagnostic communication simultaneously. In other words, the diagnostic port 61 of the vehicle 60 can be used simultaneously for multiple different purposes.

The onboard device 30 manages the vehicle data acquisition schedule according to the manifest indicating the vehicle data acquisition conditions. Additionally, the onboard device 30 generates diagnostic commands suitable for the mounted vehicle 60 and interprets responses from the mounted vehicle 60 according to the diagnostic command information and frame interpretation information. Therefore, application developers can develop diagnostic applications 411 even if they lack knowledge about the diagnostic communication of the vehicle 60 to which the apps are distributed.

In the onboard device 30, by creating routing information, the correspondence between the transmitted diagnostic commands and the requesting applications is established. Therefore, even if duplicate commands are deleted due to overlapping transmission requests for the same command at the same tick timing, the acquired vehicle data can be correctly provided to all requesting applications by referring to the routing information.

In the onboard device 30, if transmitting all the transmission candidate commands extracted from the command management table may cause overload, load adjustment is performed. In load adjustment, some of the transmission candidate commands are excluded from the transmission target or adjusted to be processed in subsequent ticks. Therefore, the traffic on the CAN bus 62 can be kept within the allowable range, and delays or other impacts on the transmission and reception of regular commands (e.g., vehicle control commands) between ECUs 63 can be suppressed. Additionally, application developers can develop diagnostic applications 411 that operate safely without knowledge of the traffic limitations of the CAN bus 62 in each vehicle 60.

In the onboard device 30, for periodic drive requests, the priority is set lower as the period value increases. In other words, the impact of the delay caused by the processing being postponed due to overload is relatively smaller for commands with larger period values. Therefore, the impact on the functions realized by the requesting applications can be minimized.

### (Other Embodiments)

While the embodiments of the present disclosure have been described above, the present disclosure is not limited to the above-described embodiments and can be implemented in various modified forms.

In the above embodiments, when there is no excludable command during overload, the processing of low-priority commands is delayed. However, the processing of commands related to immediate drive or event drive may also be delayed.

In the above embodiments, diagnostic communication on the CAN bus 62 is based on alternating transmission, as shown in the upper part of FIG. 14, where each command is completed one by one by waiting for a response from the vehicle. The present disclosure is not limited to alternating transmission and may also use parallel transmission, as shown in the lower part of FIG. 14, where commands are transmitted without waiting for responses from the vehicle. In this case, it is necessary to adjust the number of commands that can be transmitted in parallel to ensure that the traffic does not exceed the allowable range.

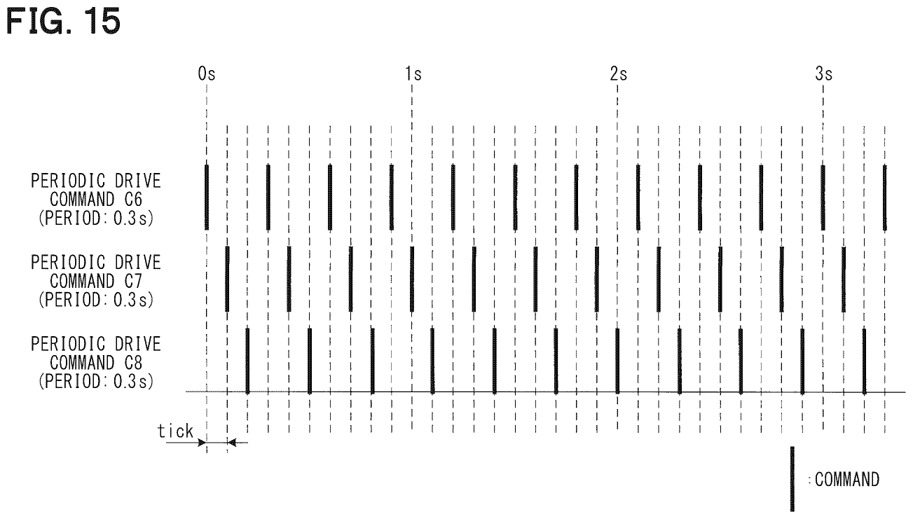

In the above embodiments, when adding management information to the command management table according to the manifest, the initial value of the “Transmission Wait Status” is set to a value corresponding to the period value. The initial value of the “Transmission Wait Status” may be adjusted to prevent transmission candidate commands from concentrating in the same tick. For example, as shown in FIG. 15, if there are three periodic drive commands C6 to C8 with an acquisition period of 3 ticks, the initial value of the “Transmission Wait Status” may be adjusted during the registration of management information so that each periodic drive command C6 to C8 is processed in different ticks.

In the above embodiments, in S120 of the schedule adjustment process, the adjustment unit 482 refers to the “Transmission Status” in the command management table and extracts all management information with a remaining tick count set to 0, i.e., all management information to be processed in the next tick, as transmission candidate commands. However, the method of extracting transmission candidate commands is not limited to this. For example, in S120, the adjustment unit 482 may refer to the “Transmission Status” in the command management table and extract all management information with a remaining tick count set to 1, i.e., all management information to be processed in the next tick but one, as transmission candidate commands. In this case, in S130 to S190, the transmission candidate commands to be processed in the next tick but one, extracted in S120 of the current schedule adjustment process, are narrowed down. In S200, the transmission candidate commands with a remaining tick count set to 0, i.e., the transmission candidate commands extracted and narrowed down in the previous schedule adjustment process, may be processed as transmission target commands.

When adopting this schedule adjustment process, the “Transmission Wait Status” for the immediate drive “mode attribute” may be set to a predetermined number of 1 or more when a request from the diagnostic application 411 occurs. Similarly, the “Transmission Wait Status” for the event drive “mode attribute” may be set to a predetermined number of 1 or more when the specified trigger conditions are satisfied.

In S120 of the schedule adjustment process, the adjustment unit 482 may refer to the “Transmission Wait Status” in the command management table and extract all management information with a remaining tick count set to a predetermined number greater than 1 as transmission candidate commands. In S200, the adjustment unit 482 may refer to the “Transmission Wait Status” in the command management table and process the transmission candidate commands with a remaining tick count set to 0 as transmission target commands. In this case, the “Transmission Wait Status” for immediate drive “mode attribute” may be set to a predetermined number of ticks or more when a request from the diagnostic application 411 occurs. Similarly, the “Transmission Wait Status” for event drive “mode attribute” may be set to a predetermined number of ticks or more when the specified trigger conditions are satisfied.

In the above embodiments, S120 to S190 of the schedule adjustment process are executed for each transmission period, i.e., for each tick, but they may be executed for multiple transmission periods, for example, every 2 ticks. In this case, in S120, the adjustment unit 482 may refer to the “Transmission Wait Status” in the command management table and extract all management information with a remaining tick count set to 0 or 1 as transmission candidate commands. In this case, in S130 to S190, the transmission candidate commands extracted in S120 are narrowed down. In S200, all transmission candidate commands that remain without being excluded by the narrowing down process may be processed as transmission target commands.

In the above embodiments, immediate drive is a mode used to acquire specified vehicle data “immediately” only once according to instructions from the diagnostic application. However, as described in the variations of the schedule adjustment process, the “Transmission Wait Status” for immediate drive “mode attribute” may be set to a predetermined number of ticks 1 or more instead of 0 when a request from the diagnostic application 411 occurs. In other words, instead of acquiring vehicle data “immediately,” it may be acquired within a limited time. In this case, the “mode attribute” can be understood as application drive, which is a higher-level concept of immediate drive. Application drive is a mode for acquiring vehicle data in response to requests from application programs.

In the above embodiments, the tick count set as the “Transmission Wait Status” for immediate drive or event drive “mode attribute” indicates the timing for executing the process, but it may indicate the latest allowable timing for executing the process. In this case, in the schedule adjustment process, if there is room in the processing load, transmission candidate commands with a remaining tick count other than 0 may be added to the transmission target commands for processing.

The control unit 31 and its methods described in the present disclosure may be realized by a dedicated computer provided by configuring a processor and memory programmed to execute one or more functions embodied in a computer program. Alternatively, the control unit 31 and its methods described in the present disclosure may be realized by a dedicated computer provided by configuring a processor with one or more dedicated hardware logic circuits. Alternatively, the control unit 31 and its methods described in the present disclosure may be realized by one or more dedicated computers configured by a combination of a processor and memory programmed to execute one or more functions and one or more hardware logic circuits. The computer program may be stored in a non-transitory tangible recording medium readable by a computer as instructions executed by the computer. The methods for realizing the functions of each part included in the control unit 31 do not necessarily need to include software, and all the functions may be realized using one or more hardware components.

The multiple functions possessed by one component in the above embodiments may be realized by multiple components, or one function possessed by one component may be realized by multiple components. Conversely, the multiple functions possessed by multiple components may be realized by one component, or one function realized by multiple components may be realized by one component. Additionally, some parts of the configuration of the above embodiments may be omitted. Furthermore, at least some parts of the configuration of the above embodiments may be added to or replaced with the configuration of other embodiments.

In addition to the onboard device 30 described above, the present disclosure can be realized in various forms such as a system including the onboard device 30 as a component, a program for making a computer function as the onboard device 30, a non-transitory tangible recording medium such as a semiconductor memory recording the program, and a data provision method.

What is claimed is:

1. An onboard device comprising:
a data acquisition unit configured to execute a transmission process to send a command used to acquire vehicle data to an in-vehicle network;
an application execution unit configured to execute at least one application program that utilizes the vehicle data acquired by the data acquisition unit;
a schedule management unit configured to extract, as a transmission target command that is a command to be a transmission target in the transmission process, the command indicated by management information that meets an acquisition condition, using one or more management information indicating a type of the command used to acquire the vehicle data, a requesting application that is the application program to be a request source of the vehicle data, and the acquisition condition of the vehicle data, and to generate routing information associating the transmission target command with the requesting application; and
a routing unit configured to provide the vehicle data acquired by the data acquisition unit through execution of the transmission process to the requesting application using the routing information.

2. The onboard device according to claim 1, wherein:
the data acquisition unit is configured to repeatedly execute the transmission process at a preset execution cycle; and
the schedule management unit is configured to extract, as a transmission target command to be transmitted in a next and subsequent execution cycles, the command indicated by the management information that meets the acquisition condition.

3. The onboard device according to claim 1, wherein
the schedule management unit is configured to obtain a manifest associated with the application program, which describes a type of the vehicle data requested by the application program and the acquisition condition of the vehicle data, from a distribution source of the application program, and to generate the management information according to the manifest.

4. The onboard device according to claim 3, wherein
the manifest includes, as a method for specifying the acquisition condition of the vehicle data:
periodic drive, which repeatedly acquires data at a fixed interval;
application drive, which acquires data in response to a request from the application program; and
event drive, which acquires data when a specified event occurs.

5. The onboard device according to claim 3, wherein:
the manifest includes, as a method for specifying the type of the vehicle data:
a name designation, which specifies the type of the vehicle data using a standardized name representing meaning of the vehicle data; and
a command designation, which specifies the type of the vehicle data in a format transmitted and received on the in-vehicle network.

6. The onboard device according to claim 3, further comprising:
a peripheral information acquisition unit configured to obtain peripheral information, including information for interpreting a frame received from the in-vehicle network of a vehicle to which the onboard device is connected, and information indicating a list of a command usable in the vehicle, through wireless communication with a server provided outside the vehicle,
wherein
the data acquisition unit is configured to convert the management information based on the manifest into a format transmittable on the in-vehicle network using the peripheral information, and to interpret a response from the in-vehicle network using the peripheral information.

7. The onboard device according to claim 1, wherein
the schedule management unit is configured to exclude a part of the transmission target command from a processing target of the transmission process to prevent overload of the in-vehicle network when transmitting all transmission target commands extracted from the management information in the transmission process may cause overload.

8. The onboard device according to claim 7, wherein
the schedule management unit is configured to determine overload when a traffic on the in-vehicle network exceeds an allowable value.

9. The onboard device according to claim 2, wherein
the schedule management unit is configured to exclude a part of the transmission target command from a processing target of the transmission process to prevent overload of the in-vehicle network when transmitting all transmission target commands extracted from the management information in the transmission process may cause overload,
wherein,
the schedule management unit is configured to determine overload when a total turnaround time of the transmission target command exceeds a period of the execution cycle.

10. The onboard device according to claim 9, wherein
the turnaround time is measured at a startup of the onboard device.

11. The onboard device according to claim 9, wherein
the turnaround time is measured when there is a change in a hardware configuration connected to the onboard device or there is a change in a software configuration of the application program executed by the application execution unit.

12. The onboard device according to claim 2, wherein
the schedule management unit is configured to exclude a part of the transmission target command from a processing target of the transmission process to prevent overload of the in-vehicle network when transmitting all transmission target commands extracted from the management information in the transmission process may cause overload,
wherein,
the schedule management unit is configured to adjust the management information so that the management information excluded from the transmission target command is extracted as a transmission target command in an execution cycle after an execution cycle in which the management information excluded from the transmission target command is excluded.

13. The onboard device according to claim 7, wherein:
the management information includes a priority related to transmission of the command; and
the schedule management unit is configured to exclude the management information with lowest priority or a priority below an excludable threshold from the transmission target command when overload is determined.

14. The onboard device according to claim 13, wherein
the priority is set according to a data type of the vehicle data acquired by the command.

15. The onboard device according to claim 13, wherein
the priority is set according to the acquisition condition of the vehicle data acquired by the command.

16. The onboard device according to claim 1, wherein:
the vehicle data acquired by the data acquisition unit includes at least one of: vehicle speed; total traveled distance; vehicle body acceleration; vehicle body angular velocity; GPS position information; gear position; battery charge state; fuel tank capacity; remaining fuel amount; average fuel consumption; light status; interior and exterior temperature; air conditioner operation status; door and window open/close status; door and window lock status; seatbelt status; airbag status; tire pressure; parking brake status; accelerator pedal position; brake pedal position; brake pressure; or diagnostic trouble code list.

17. The onboard device according to claim 1, wherein:
the onboard device is connected to the in-vehicle network via a diagnostic port provided in a vehicle; and
the data acquisition unit is configured to use a diagnostic command used in diagnostic communication as the command.

18. A data provision method in an onboard device that executes a transmission process to send a command used to acquire vehicle data to an in-vehicle network and provides the vehicle data acquired by the transmission process to at least one application program, wherein the vehicle data is provided to a requesting application that is the application program to be a request source of the vehicle data, the method comprising:
using one or more management information indicating a type of command used to acquire the vehicle data, the requesting application that is a request source of the vehicle data, and an acquisition condition of the vehicle data;
extracting, as a transmission target command that is a command to be a transmission target in the transmission process, the command indicated by the management information that meets the acquisition condition;
generating routing information associating the transmission target command with the requesting application; and
providing the vehicle data acquired by executing the transmission process to the requesting application using the routing information.

19. A non-transitory computer readable storage medium storing a program executed in an onboard device that executes a transmission process to send a command used to acquire vehicle data to an in-vehicle network and provides the vehicle data acquired by the transmission process to at least one application program, wherein the vehicle data is provided to a requesting application that is the application program to be a request source of the vehicle data, the program causing the onboard device to:
use one or more management information indicating a type of command used to acquire the vehicle data, the requesting application that is a request source of the vehicle data, and an acquisition condition of the vehicle data;
extract, as a transmission target command that is a command to be a transmission target in the transmission process, the command indicated by the management information that meets the acquisition condition;
generate routing information associating the transmission target command with the requesting application; and
provide the vehicle data acquired by executing the transmission process to the requesting application using the routing information.
